(19) United States
(12) Patent Application Publication
(10) Pub. No.: US 2003/0224802 A1
(43) Pub. Date: Dec. 4, 2003

(54) Locating a mobile unit

(76) Inventors: Joseph Nir, Rehovot (IL); Baruch Shayevits, Lezion (IL); Hanoch Cohen, Lezion (IL)

Correspondence Address: Mark Friedman, Bill Polkinghorn, Discovery Dispatch, 9003 Florin Way, Upper Marlboro, MD, 20772, US

(21) Appl. No.: 10/221,474

(22) PCT Filed: Mar. 27, 2001
(86) PCT No.: PCT/US01/09696

(30) Foreign Application Priority Data
Mar. 30, 2000 (US) 60193234

(51) Int. Cl. H04Q 7/20

(52) U.S. Cl. 455/456.1; 455/427

(57) ABSTRACT

A mobile receiver unit (12) of the GPS navigation satellite system is located in accordance with the present invention relative to a reference unit (14) of the same satellite system having known geographic location parameters. Within the frame work of a cell of a cellular network, a plurality of signals of the respective number of radio sources are received by a MU (mobile unit) and by a reference unit. The differences in time of reception of time related structures of the signals are calculated. The difference between the calculated reception time and the measured reception time of each of the respective signals is used to calculate the distance to the radio sources and to the reference unit. Compensation for radio clock drift is performed when required to radio sources by comparing nominal time related structure transmission rate with measured structure transmission rate as referenced by a satellite signal containing a sequence of time related structures.

### FIELD OF THE INVENTION

The present invention relates generally to methods for locating mobile receivers, having combined circuitry for receiving satellite and wireless communication networks. More specifically the present invention relates to navigation of mobile receivers relative to other mobile units using pseudoranging principles.

### BACKGROUND OF THE INVENTION

A standard GPS receiver determines its position relative to the SV constellation by measuring propagation time of signals transmitted simultaneously from several Navstar satellites (SVs) This constellation consists of 24 SVs each orbiting the earth in 12 hours time, such that any user, if unobstructed, has always a line of sight to 5-10 SVs. Each SV transmits a continuous pseudorandom (PRN) noise sequence of characteristic code in discrete code periods, each such code period containing a sequence 1023 chips sent at a rate of 1023 KHz. Each SV has its own particular PRN sequence, which has good correlation properties and is orthogonal to the PN sequences of the other SVs.

Superimposed on the PRN sequence is a SV data message. The data message includes position data (almanac and ephemeris), clock timing data and system time data. The GPS receiver processor locks on a specific visible SV signal using correlation techniques often performed by a correlator, to correlate between the received signals and a known replica of the transmitted signal from the SV. Operative along the principles of the pseudoranging concept are SV radio sources of the highly synchronized Navstar constellation (GPS) SVs, which is freely available to any user. In the location procedure according to the pseudoranging concept, the travel time of a signal from the source to the receiver is obtained, and thereupon used as a basis for calculating the distance between the radio source and the receiver. To obtain the travel time of a signal from the SV to a respective receiver, a stepwise correlation is performed between the specific satellite code and a stored replica code of the same satellite, such that the time for achieving full correlation with the locally stored code is the time of arrival. The timing measurements performed by the receiver, contain an unmeasurable component which is caused by the offset of the receiver's local clock relative to the satellite system's own clock, lowering the accuracy of the whole measuring system. The measured travel time of a signal from a source to a receiver is described as a summation of two quantities, a first quantity which is the actual travel time as if measured by an accurate reference system, and a second quantity which is the bias of the mobile receiver clock at the time the measurement was done, with respect to the satellite clock. In order to overcome the specific problem, an additional measurement is taken to an extra satellite, so that a set of N+1 equations each describing the travel time of the respective satellite signal to the receiver is formed. The receiver is however searched in a N dimensional space. The employment of an extra measurement allows for cancellation of the clock offset by solving the set of N+1 equations having N+1 number of unknowns, including the receiver clock thus solving the travel times.

Cellular wireless networks communicate with a large number of subscribers over a narrow bandwidth allocated to each provider. The tight restrictions on bandwidth is compensated for by an extensive use of logical channels modulated on the physical bands. Such a system requires a high degree of synchronization between the mobile subscribers and the network. To that end that the network employs a scheme of timing synchronization signals between the network and the mobiles.

The expanding usage and deployment of wireless cellular communication systems promoted the development of new approach to subscriber navigation systems based on the timing mechanisms of these networks. U.S. Pat. No. 5,999,124 discloses a method for incorporating the signals of a cellular network system for augmenting a navigation system based on satellites. This is achieved by measuring the travel time of a signal between a cellular system and a receiver of the system. Various kinds of assistance data regarding the satellites can be stored in the network and supplied to the mobile units upon request. Such is almanac data which provides a rough projection of the orbit position of the various satellites of the constellation for weeks ahead. The almanac data can be stored for several weeks before updating is required and helps the receivers to shorten location procedures and increase sensitivity to weak signals, as well as predict Doppler parameters for each satellite.

### SUMMARY OF THE INVENTION

An object of the present invention is to provide a system and a method for locating a mobile receiver of a navigation satellite constellation, by determining the distance to a stationary receiver of the same satellite constellation.

Another object of the present invention is to provide a method for determining the location of a MU (mobile unit receiver) of a constellation of navigation satellites by measuring the difference between reception time of a navigation satellite signal in the MU and a reference receiver unit having known location parameters. This measurement is made possible by providing a common time reference to both MUs. The common time reference are the uniquely identifiable time related structure of the signal of the BTS (base transceiver station) of a cellular network. The BTS clock drift is measured with reference to the satellite code period flow, to be corrected accordingly.

A further object of the present invention is to provide a method for determining the location of a MU of a navigation satellite system relative to another receiver of the satellite system, by exploiting the code period sequence of the navigation signal, without the need to down load further data modulated into the signal. This reduced requirement enables to exploit the satellite system under conditions in which a low power signal is received and the signal cannot be demodulated.

A further object of the invention is to provide a system and method for locating a mobile receiver of a cellular network with reference to another receiver of the same cellular network, within the frame-work of one cell.

### BRIEF DESCRIPTION OF THE DRAWINGS

FIG. 1 is a schematic illustration describing the framework of radio transmitters and receivers among which the present invention is implemented.

FIG. 2 is a flow chart describing schematically the sequence of interactions between the two receivers of the invention.

FIG. 3 is a graphic illustration describing in approximation the quantitative geometric relationships between the receivers the satellite.

FIG. 4 is a schematic representation of the structural and temporal properties of the signals of the radio sources being correlated by the procedure of the invention.

FIG. 5 is a schematic representation of the measured time in BTS units versus time in SV units elapsing between the two snaps carried out in the procedure of the invention.

FIG. 6 is a geometric scheme describing the relationship between the position of the SV relative to the receivers in the differential measurement method.

### DETAILED DESCRIPTION OF THE PRESENT INVENTION

Radio Sources and Received Signals

A GPS satellite (SV) navigation signal contains one msec (millisecond) long consecutive contiguous repetitions of a binary code sequence called code period, or C/A code period. Each msec a new code period is transmitted enabling receivers to perform correlation between the transmitted code and a stored replica of the specific code characterizing the SV, and facilitating determination of pseudorange from each receiver to the specific SV. Under certain conditions, the MU (mobile receiver unit) of a navigation satellite constellation is capable of receiving the signal of the satellite, yet, it is unable to extract vital information modulated in the signal, system time and ephemeris of the SVs, which is required for determining a location of the MU in geographical terms. Under the same conditions however. If the reception of the SV signal is above a minimal power threshold, a correlation with a stored replica of the code in the receiver may be performed, providing pseudorange to that SV.

In accordance with the present invention, the location of a MU (mobile unit) is determined relative to a second unit, typically a mobile unit fixed in place. Radio signals of both navigation SVs, typically of the GPS constellation, and of BTSs (base transceiver stations) of a locally deployed cellular network are used in the procedure of the invention

System Layout

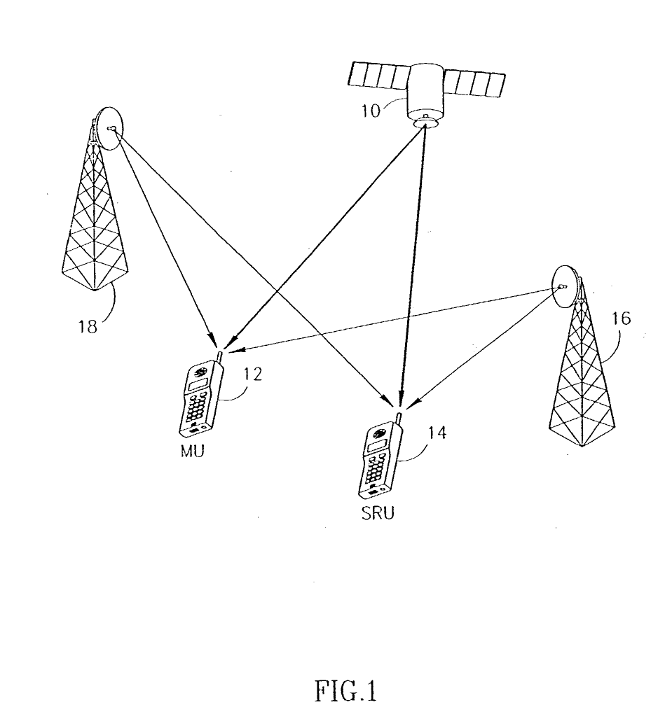

Reference is now made to FIG. 1 which portrays the fundamental layout of radio sources and receivers according to a preferred embodiment of the present invention. GPS SV 10 transmits navigation data received by a first mobile receiver unit 12 (MU) and by a second, immobile unit 14, referred to hereafter as a stationary receiver unit (SRU). The receiver units are nodes of a GSM cellular network, wherein BTS1 (base transceiver stations) 16 and BTS2 18 are stationary nodes of that network. More radio sources may be employed in the system of the invention, more BTSs and more SVs A calculation center of network node (not shown) may be used for the purpose of storing information and calculating locations. Each of the receiver units of the invention contain a receiving circuitry for the navigation SVs (typically of the GPS system), a receiving unit for the BTSs, including antennas A downconverter is employed for transforming the received RF into lower frequency signals. At least one digitizing component for converting the downconverted signal of both source types is employed, and at least one processor for extracting information from the received signals. A local clock is incorporated in each of the receiver units for providing the rate of the digitizing component.

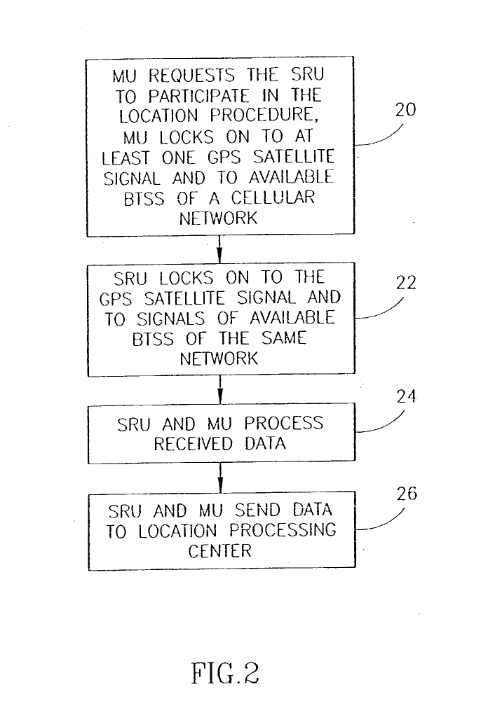

In FIG. 2 to which reference is now made, is shown in a generalized form a sequence of interactions between the two receivers, in accordance with the present invention. In step 20, a MU sends a locate request to the SRU to participate in the location procedure, MU locks on to at least one GPS SV signal, and to available BTSs of a cellular network. In step 22, the SRU in response locks on to a GPS SV signal and to the BTSs of the same network as the MU. In step 24 both MU and SRU process data which they receive. In step 26 both MU and SRU send the processed data to the location processing center. This center may be located in a processing center of the network, or in one of the mobile or stationary units. Alternatively, the MU may not start the procedure before the SRU has responded. Another option is that the MU first locks on a SV, before sending a locate request to the SRU. In each case, the SRU may be the first receiver to start collecting data.

Data Transfer

Table 1 lists the types of data received by the MU and the respective sources, sole or alternative for each data type.

TABLE 1

| Data type received | Available source |
|---|---|
| 1. GPS code periods | 1. At least one GPS SV. |
| 2. BTS transmission | 1. All available BTSs |
| frames | 2. respectively. |
| 3. GPS almanac | 1. Network |
| | 2. MU |

Table 2 lists the types of data received by the SRU and the respective sources, sole or alternative for each data type.

TABLE 2

| Data type received | Available source |
|---|---|
| 1. GPS code periods | 1. At least one GPS SV. |
| 3. BTS transmission | 1. All available BTSs |
| 4. frames | respectively. |
| 3. GPS almanac | 1. Network |
| | 2. Locally received |
| 4. GPS system time | 1. A GPS SV |
| 5. GPS ephemeris - | 1. A GPS SV |
| optional | |
| 6. SRU geographic | 1. Local memory |
| location | 2. Network |
| | 3. Locally calculated |

A location computation server (LCS) is optional in an embodiment of the invention. Such a center accepts measurement carried out in the MU and SRU. It also accepts geographical data from the BTSs and the SRU, to subsequently calculate the location of the MU in geographical coordinate or in terms of distance and direction of the of the MU to the SRU.

Determination of Location of the MU

The method of the present invention is differential, whereby the location determination is performed by finding a difference in pseudoranges between a MU and a SRU to at least one GPS SV, and pseudoranging to at least one BTS. In accordance with the present invention, there is no need for the MU to extract the full navigation information modulated on the GPS signal. Rather, the signal that must be received by the MU in accordance with the present invention is such that the code periods are discerned, which requires a minimal signal power. These code periods are required for correlating to be made between a GPS receiver and the GPS SV signal, using a pseudo random code. All other data modulated on the SV signal including ephemeris, time of week, which are required for regular GPS positioning, require a signal power to be extracted.

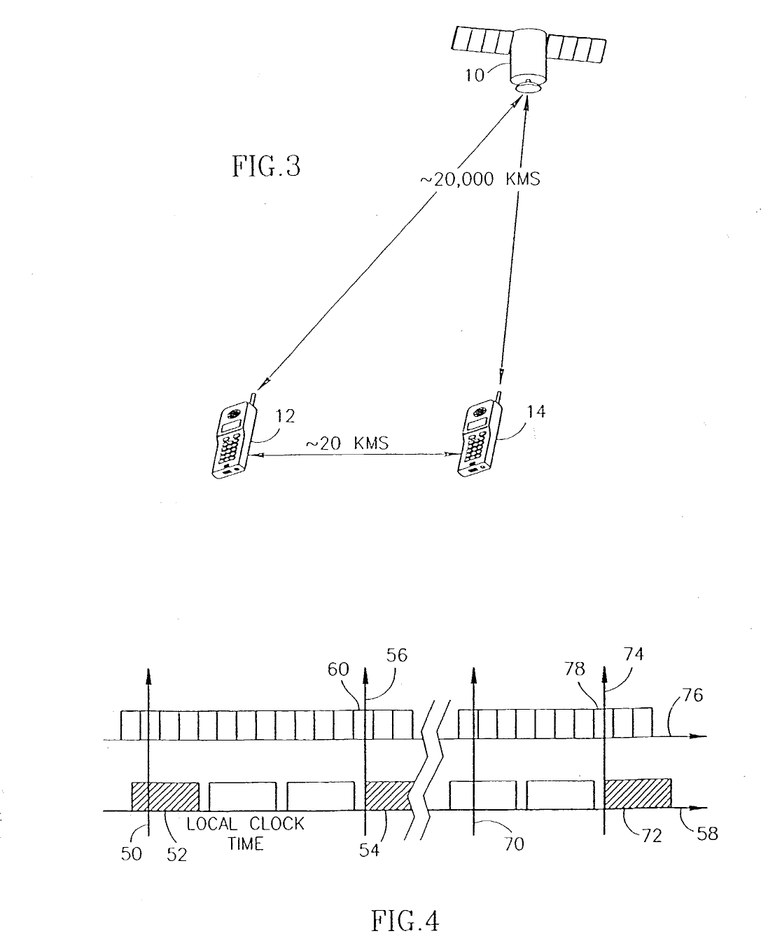

Reference is now made to FIG. 3 describing the geometric relationships between two receivers and a GPS SV in the context of the conditions of the present invention. MU 12 and SRU 14 receive signal of SV 10, composed of contiguous 1 msec (millisecond) long code periods. The figure is out of scale because the distance of the SV to the receivers is more than 20,000 kms and the distance between the receivers is roughly a cellular network cell diameter or less, which accounts for a maximum of a few tens of kms. For a code period it takes less time to reach SRU receiver 14, which is slightly closer to SV 10, than it takes for the same code period to reach receiver 12, which is farther away from the SV 10, because the line of sight from this receiver is more slanted as can be seen in the figure. In the present invention the actual time it take to the signal to travel from the SV to each of the receivers is not measured, rather, the difference between the time it takes for the same signal to reach each of them is measured.

In accordance with the present invention the difference in pseudoranges between the receivers to the SV is measured, as will be explained next. In order to determine the difference in pseudoranges, first the difference in reception time of the same signal between the two receivers must be made as will be explained next. In a first snap, which in one embodiment is performed by the MU, the receiver first locks on to a SV. Reference is made now to FIG. 4 which describes the way in which time related structures of the signals of the radio sources are used for determining the location of a MU in an embodiment employing one GPS SV and two cellular BTSs (one of which is not shown). Snap 1 begins at local clock time of the SRU, marked by arrow 50, in which BTS1 signal and SV signal are received and sampled concomitantly. The BTS1 signal is composed of consecutive discrete frames each measuring 4.615 msecs. These frames are shown on the lower time axis 56, and SV code periods are received as shown on the upper time axis 76. The local clock determines the rate of sampling of the signals of the radio data, but it also keeps record of the universal time, which is required for referencing with other nodes of the network. All frames are composed of discrete time slots, each containing bits. Among the frames, some are individually identifiable by their specific structure, are regularly spaced over time, and are hereinafter referred to as ITF (identifiable time frame). Such are, for example, the synchronization frames of the GSM system. Each individual ITF has a unique serial number, but all types of frames are countable, because the length of all the frame types is identical. Any difference in time between two events in the network can be referred to in terms of whole and fractional number of frames elapsing between the events. As soon as it gathers radio data, the processor looks for an ITF, and for the sake of convenience the ITF start is specifically looked for. In FIG. 4 all the ITFs appear as hatched boxes, and non ITF frames are marked as clear boxes, on the lower time axis 58. Therefore, frame 52 was the first frame that the processor identified, and was also an ITF, but since it was received after it had started, the next ITF is registered as the first ITF encountered of received BTS frames. The processor looks for a ITF start, thereby registering the start of frame 54 as such. This point on the time axis, is marked by arrow 56 and is referred to hereinafter as T_{SRU-0}. In parallel, the code period fraction (CPF), which is established by arrow 56 is recorded as well, i.e. the distance between the left end (start) of code period 60 and T_{SRU-0}, or the complement to one msec, that can be either calculated or measured from T_{SRU-0} onwards. As soon as the locate request arrives at the other receiver, which in the foregoing explanation is the MU, a second snap starts, at arrow 70. Once again registering a start of the first ITF encountered. In this example, the start of frame 72 is indicated by arrow 74, which will hereinafter be called T_{MU-0}. In parallel, the matching CPF which is determined by T_{MU-0} is recorded. In this snap, the length of CPF (fraction of code period) of code period 78 is determined either by measuring the distance between the start of code period 78, or by calculating its complement to 1 msec, or measuring the distance from T_{MU-0} to the end of code period 78.

The difference in time between snap 1 and snap 2 is variable depending for example on SMS transfer from the SRU to the MU. In order to compare the reception time of a SV signal in the SRU (snap 1) with the reception time of the same signal in the MU (snap 2), a time correlation must be made between the two snaps. Such a time correlation is provided by the BTS1 signal. The time between ITF 54 and ITF 72 is known because this value is a projection of the working standards of the GSM network.

For example, if ITF 54 is a synchronization frame, the number of whole frames between this frame and a consecutive synchronization frame is intrapolated by reference to the transmission rate of synchronization frames. In order to measure the difference in reception time of a SV signal between the receivers as required by the procedure of the invention, the equivalent number of the GPS code periods elapsing between the two ITF on the SV time axis 76, i.e. between T_{SRU-0} and T_{MU-0}, is calculated as shown in FIG. 5, to which reference is now made:

Total time difference between T_{SRU-0} and T_{MU-0}=ΔT₀ (number of whole frames between the two arrows). On the GPS time axis, this period equals to the total number of whole code periods plus two fractional code periods, one fractional code period at the beginning and one at the end of the measurement period. Accordingly, ΔT₀ equals on the SV time axis to the total of the following: the length of CPF of code period 78 which abuts arrow 74 (T_{MU-0}) at its left, plus the length of the CPF to the right of arrow 56, plus a continuum of whole code periods starting to the right of code period 60 and ending in code period 78 In mathematical terms: ΔT₀ (the nominal time between discerned ITFs, or in other words the number of frames between T_{SRU-0} and T_{MU-0}) equals to: the CPF (code period fraction) between T_{SRU-0} and end of code period 60 to the right of arrow 56 (b), plus a plurality of contiguous whole code periods (c) plus the CPF of code period 78 to the left of T_{MU-0} (d).

1. ΔT₀=b+c+d=c+(b+d); Equation 1:

with the sum of fractional code periods (in brackets) substituted by a equation 1 becomes:

2. ΔT₀=a+c. Equation 2:

To calculate a:

4. ΔT₀MOD1 msec=a. Equation 3:

The CPF a is a calculated part of the nominal tract on the time axis. A limiting distance condition for implementing the invention is, as mentioned above, the area size of a cell of the cellular network. Such a limiting condition dictates a maximal difference between measured to calculated values of time of reception to less than one unit code period. This explains the use of modulo arithmetic to calculate differences between calculated and measured reception times. The location offset between the two receivers with respect to the radio sources is utilized for calculating the geometrical (geographical) offset (range) between the MU and the SRU and the BTSs. For the determination of the time of reception of the respective signals of the SV and of the BTS in the two receivers, more factors are to be considered:

a. BTS1 Clock drift

b. SV clock drift.

c. SV position change occurring between and during the snaps.

d. SV Doppler offset.

e. Selective Availability (SA), which is an intentional mechanism that reduces system accuracy.

The implementation of the invention will be explained further, taking in account the above listed items.

Compensating for BTS Clock Drift

Measuring the BTS1 clock drift is performed by referencing the BTS clock rate to a higher stability clock, namely SV clock. To accomplish this, the first snap is continued beyond the time required for completion of the first ITF start reception. The snap continued thus to a period of a few seconds. The drift is calculated by comparing the number of n frames (including fraction of frames) bound by the limits of a continuum of m code periods, with the cumulative time of that continuum. Mathematically:

$$\text{Equation 4:} \\ {drift}_{BTS} = 1 - \frac{n frames \times nominal frame time}{m code periods ( corrected for Doppler offset )}$$

Which can be normalized, for example, to one msec. This ratio determines the number of measured BTS frames and SV time as measured by code period flow. As the BTS drift is not dependent upon the MU and is considered linear for the duration of a measuring period. The correction factor which has been obtained in the first snap, can be used for correcting the measurements made in the second snap.

It is also possible to measure the drift as it builds over two snaps. In such a method, the first snap is not continued beyond the acquisition of the first ITF, and the n of frames of equation 4 are counted by interpolation between the respective ITFs of the two snaps, in accordance with the working standard of the frame rate. This n is divided by the number of period measured, corrected for Doppler offset.

The actual measurement of the BTS clock drift can be implemented in the MU or in the SRU, but in each case it is transferred to the other receiver or to the calculation center to complete the location calculation

Compensating for SV Clock Bias

In the procedure of the present invention, which is a differential method, both receivers obtain their SV signal from the same SV and bias is cancelled out. If more than one SV is used in accordance with other embodiments of the present invention, for each SV used the signal is differentially processed.

Satellite Position Error and Changes Occurring During the Snap Measurements

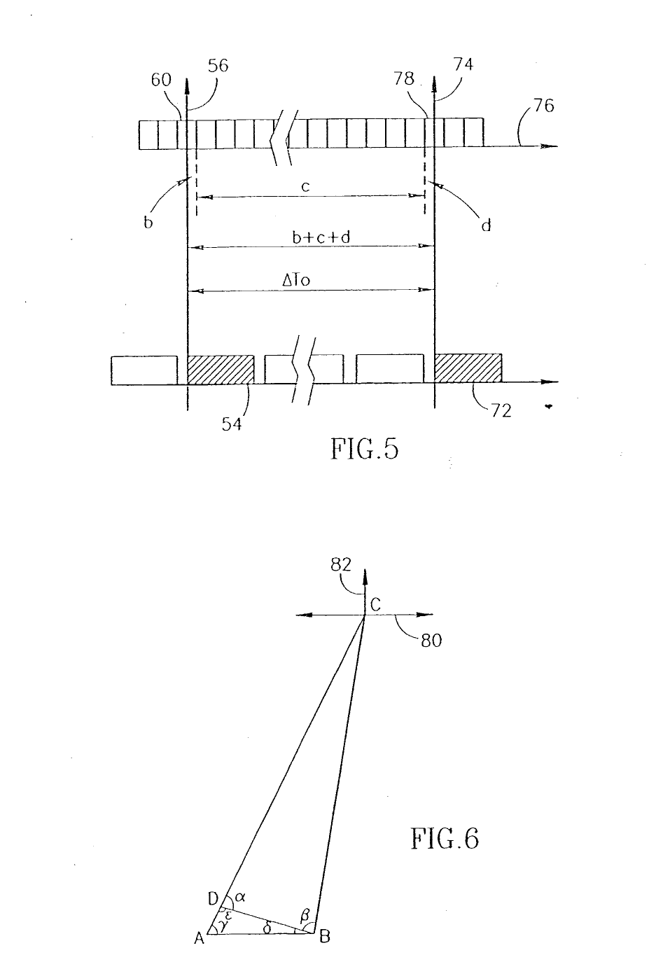

In the method of the invention, SV position is obtained initially from the SV system almanac database, which can be stored aboard the MU, in the SRU or in the network, such as in the LCS. An assumption is made that the conditions for the implementation of the invention are such that the almanac database is sufficiently accurate for calculating the location of the MU. The error incurred by the use of almanac data is in the limits of tens of kms per given time. This is further explained in FIG. 6 to which reference is now made. In triangle ABC, C represents the position of the SV which is displaced more that 20,000 kms away from the earth's surface. The section AB represents the distance between the two receivers which is typically smaller than 30 km. In the differential ranging method of the invention, the difference between respective pseudoranges from each receiver to the SV is measured, which is illustrated as follows: the distance from one receiver to the SV is represented by the side BC, whereas the distance between the other receiver to the SV is represented side AC. Triangle ABD is an isosceles triangle wherein section DC=side BC. The section AD therefore represents the difference in ranges between the receivers to the SV. By definition, the angles α=β, which means that α cannot have a value of 90° or larger, which means that the complementary angle to α, namely angle ε on the strait line AC equals 180−α, and is therefore always larger than 90°. This means that side AB is the longest in the triangle ABD and that angle δ is the smallest angle in triangle ABD which means in this case that the section DA is the shortest in the triangle. This further means that for any displacement of C along line 80, DA is smaller than AB, for any AB. DA becomes smaller as C is displaced in the direction of arrow 82, because the farther C is displaced away from AB, the larger angle γ becomes. Since ε is always larger than 90°, angle δ will become extremely small for large distance of C. In addition, the shorter AB is, the larger angle γ is, for any distance of C.

In regular pseudoranging to SVs, each receiver measures its distance to the SV independently, requiring ephemeris data for having an accurate model of the SV position at the time of pseudoranging, for determining the geographical location of the MU. The differential measurement method of the present invention results in a diminution of the effect of the error in SV position caused by utilizing the almanac rather then the ephemeris data.

In order to calculate the change in Doppler offset which occurs during measurement period (during the snaps and the time between), the velocity of the SV is obtained from the almanac. An average line of sight velocity (i.e. the linear velocity component directed at the receiver) is used in the location equations as will be explained later on. Alternatively, the velocity can be calculated during the navigation calculation, in the SRU, with better accuracy if the ephemeris data is acquired. In the case that the difference in time between the two snaps is very short (within the limits of about a second or less), the position of the satellite can be considered static for the purpose of geometrical calculations of location. Such a condition obviates the need for using SRU location parameters.

Selective Availability (SA) Offset and Differential Corrections

The operators of the GPS system sometimes intentionally decrease the accuracy of the system by inducing non linear changes to the signal. A usual method for overcoming the limitations set by the implementation of such accuracy is by providing correction factors to a MU from a reference receiver in what is generically called differential GPS. By using the present invention, the limitations of the SA will be overcome without using differential GPS procedures.

Calculating MU Position

The following definitions are made:

SV position at time of measurement: X_{SV}, Y_{SV},

BTS position: Y_{BTS}, Y_{BTS},

MU position: X_{MU}, Y_{MU},

SRU position: X_{SRU}, Y_{SRU},

C: speed of light,

ΔT₀: Nominal total time between the two ITFs spanning the two snaps,

c_b: Difference between local clock biases of the two receivers,

V_{AVE}: Average SV line of sight velocity.

First, a reference is made to another BTS received and processed by the MU and RSU, namely BTS2 The reception of a first ITF of this BTS2 is performed in the first snap, and a second one by the second receiver in the second snap. The rate of BTS2 is corrected for drift by the same method as BTS1 is corrected. The reception time of the first ITF in the SRU is T_{SRU}BTS2, the reception of the ITF in the next snap is T_{MU}BTS2.

To extract MU position parameters from the BTS reception times, for each BTS the measured time differences between ITFs is calculated, for each BTS separately, subtracting the corrected nominal time respectivel. Thus, for BTS1,

ΔT(_{BTS1})=T_{MU-0}−T_{SRU-0}−ΔT₀×(1+correction factor for BTS1 drift)+c_{—}b Equation 4

ΔT(_{BTS2})=T_{MUBTS2}−T_{SRUBTS2}−ΔT₀×(1+correction factor for BTS2 drift)+c_{—}b Equation 5:

From equation 4, the following Pythagorean equation is formed

C×ΔT(_{BTS1})={square root over (((X_{SRU}^{-X}_{BTS1})²)}+(Y_{SRU}−Y_{BTS1})−\sqrt{(X_{MU}−Y_{BTS1})²}+(Y_{MU}−Y_{BTS1})²)+c_{—}b×C Equation 6:

From equation 5, the following Pythagorean equation is formed

C×ΔT(_{BTS2})={square root over (((X_{SRU}−X_{BST2})²)}+(Y_{SRU}−Y_{BST1})²)−[{square root over (((X_{MU}−X_{BST2})²)}+(Y_{MU}−Y_{BST2})²)]+c_{—}b×C Equation 7:

A is a position vector from the SV to the SRU:

A=(X_{SV}−X_{SRU}),(Y_{SV}−Y_{SRU}),(Z_{SV}−Z_{SRU}) Equation 8:

Converting vector A into unit vector U=Ux,Uy (z component ignored) by dividing by its own length

$$\text{Equation 9:} \\ U = \frac{( {X}_{SV} - {X}_{SRV} ) , ( {Y}_{SV} - {Y}_{SRV} )}{\sqrt{( {( {X}_{SV} - {X}_{SRV} )}^{2} + {( {Y}_{SV} - {Y}_{SRV} )}^{2} + {Z}_{SV}^{2} )}}$$

Owing to the specific conditions of the present invention, namely differential measurements, limited geographic area of implementation, short time between data acquisition snaps, the unit vector may be considered as valid for the satellite to MU position as well. The vector will then be calculated

To extract MU position parameters from the SV reception times, the measured time differences between the SV reception time ITFs, of BTS1 is calculated, subtracting the corrected nominal time,

ΔT(_{SV})=T_{MUSV}−T_{SRUSV}−ΔT₀×(1+drift correction) Equation 10:

From Equation 10, the following Pythagorean equation is formed,

Equation 11:

$$C \times Δ {T}_{( SV )} = {U}_{x} \times ( {X}_{SRU} - {X}_{MU} ) - {U}_{Y} \times ( {Y}_{SRU} - {Y}_{MU} ) ( \sqrt{( {( {X}_{SRU} - {X}_{BTS1} )}^{2}} + {( {Y}_{SRU} - {Y}_{BTS1} )}^{2} ) - ( \sqrt{( {( {X}_{MU} - {X}_{BTS1} )}^{2}} + {( {Y}_{MU} - {Y}_{BTS1} )}^{2} ) + c\_b \times C + Δ {T}_{0} \times {V}_{AVE}$$

V_{AVE} (average SV velocity) is used to introduce the SV position change during and in between snaps, into equation 11 when the time difference between the two snaps is not larger than a few tens of seconds

Possible Combinations of Ranging Radio Sources

The present invention was heretofore explained as for reception of one GPS SV in combination with one BTS. For conditions of flat terrain with no elevation differences, three radio sources are required, for three dimensional solution another radio source is required. To comply with the basic requirements for implementing the invention, the use of one SV is mandatory, and one or more (typically two) BTSs are used. If two BTS are employed, they must be received and their signals processed in the snaps with at least one SV signal received in the same snap. Preferably, both BTSs are received and processed together.

If the two snaps of the invention can be made to occur at a very short delay period in between, such as a second or less, the method of the invention may be implemented without the need for a BTS signal at all, using at least three satellites.

1. A system for determining a location of a receiver of radio signals, wherein a first MU (mobile receiver unit) receives signals of a navigation satellite, and wherein said location is relative to a second receiver unit of said satellite system having known location parameters, and wherein said first and said second receivers are capable of receiving signals of a locally deployed cellular network, comprising:
at least three receivable transmitters of countable time related structures,
in each receiver, at least one digitizing circuit for sampling signals of said satellite system and of said cellular network,
a local clock installed in each of said receivers for determining a rate for said sampling,
at least one processor for processing said sampled data installed in each of said receivers,
at least one receivable BTS (base transceiver station) of said cellular network, producing within their signals a sequence of uniquely identifiable time related structures,
at least one navigation satellite of a constellation of navigation satellites, wherein a received navigation signal thereof is powerful enough to facilitate detection of code periods of said navigation signal, and
a connection between said receivers.

2. A system for determining a location of a receiver of radio signals, as in claim 1 and wherein said locally deployed cellular network is a GSM cellular system.

3. A system for determining a location of a receiver of radio signals, wherein a first MU (mobile receiver unit) receives signals of a navigation satellite, as in claim 1, and wherein said second receiver receives ephemeris data of said navigation satellite, thereby facilitating accurate Doppler offset calculation of said satellite.

4. A method for determining a location of a first receiver unit of radio signals within a framework of a cell of a cellular network, wherein said receiver unit and a second receiver unit receive countable time related structures of a navigation satellite signal and of said cellular network, comprising:
receiving at a first snap, by a receiver unit, a first set of radio signals transmitted by at least three radio sources, and wherein at least one source of which transmits uniquely identifiable timing frames, and wherein at least one of said radio sources is a BTS (base transceiver station) having a known set of location parameters,
receiving at a second snap by a receiver unit other than the one receiving signals at said first snap, a second set of radio signals transmitted by said at least three radio sources,
determining a difference in reception time of said time related structures of said signals of said radio source in said receivers,
compensating said differences in arrival times of BTS signals for source clock drift, and
calculating location of said first receiver unit with reference to said radio sources and with reference to said second unit.

5. A method for determining a location of a first receiver unit of radio signals within a framework of a cell of a cellular network as in claim 4, and wherein two of said radio sources are BTS of a network station, and one radio source is a GPS satellite, and wherein said identifiable structures are synchronization frames of said BTSs.

6. A method for determining within the framework of a cell of a cellular network a relative location of a MU (mobile unit) of a navigation satellite system, wherein said MU is a receiver of a cellular network, using signals of at least three radio sources, as in claim 4 and wherein at least one radio source is a GPS navigation satellite, and wherein said second receiver unit has a known set of location parameters.
